(19) United States
(12) Patent Application Publication
(10) Pub. No.: US 2016/0076829 A1
(43) Pub. Date: Mar. 17, 2016

(54) HEAT DISSIPATING SHEET

(71) Applicant: 3M INNOVATIVE PROPERTIES COMPANY, St. Paul, MN (US)

(72) Inventors: Mihee Lee, Gyunggi-Do (KR); Hun Jeong, Kyunggi-Do (KR)

(21) Appl. No.: 14/785,651

(22) PCT Filed: Apr. 22, 2014
(86) PCT No.: PCT/US2014/034858

§ 371 Date: Oct. 20, 2015

(30) Foreign Application Priority Data
Apr. 26, 2013 (KR) 10-2013-0046988

(51) Int. Cl. F28F 21/02; F28F 21/08; B32B 15/09

(52) U.S. Cl. CPC F28F 21/02; B32B 15/09; F28F 21/08; B32B 2255/06; B32B 2255/20; B32B 2307/30

(57) ABSTRACT

Provided is a heat dissipating sheet. The heat dissipating sheet includes a metal layer having a first surface and a second surface, at least one graphene layer having a first surface and a second surface, wherein the second surface of the graphene layer comes in contact with the first surface of the metal layer, a protective layer comprising (a) a substrate layer having a first surface and a second surface, wherein the second surface of substrate layer comes in contact with the first surface of the graphene layer, and (b) a pigment layer coming in contact with the first surface of the substrate layer, an adhesive layer having a first surface and a second surface, wherein the first surface of the adhesive layer comes in contact with the second surface of the metal layer, and a release layer coming in contact with the second surface of the adhesive layer, wherein the heat dissipating sheet has a thermal conductivity of 70 W/m·K or more in a horizontal direction.

### CROSS-REFERENCE TO RELATED APPLICATION

This application claims priority to and the benefit of Korean Patent Application No. 10-2013-0046988, filed on Apr. 26, 2013, the disclosure of which is incorporated herein by reference in its entirety.

### BACKGROUND

1. Field of the Invention

The present invention relates to a heat dissipating sheet for emitting heat generated in an electronic device.

2. Discussion of Related Art

In recent years, the amount of heat generated by electronic devices such as televisions (TVs), notebook computers, m

Mobile phones and the like has increased with the development of the high-performance and small-sized electronic devices. Since the heat generated by electronic devices serves to cause the malfunctioning (i.e., hitches or failures) of said electronic devices, there is a demand for technology which dissipates heat generated by electronic devices effectively.

Korean Patent Publication No. 2012-0003676 discloses a heat dissipating sheet in which graphite is coated onto a metal layer to dissipate heat generated in an electronic device. Although graphite has excellent thermal conductivity, graphite exhibits poor burst strength and tensile strength since its structure is close to a single-crystal structure. Therefore, the heat dissipating sheet having graphite coated on the metal layer has a problem in that it may be easily broken or damaged, due to poor handling while it is being applied to the electronic device.

Also, when the heat dissipating sheet is applied to and used in the electronic device, a graphite-coated layer exposed to external environments may be damaged by physical or chemical factors, which leads to degraded durability and a reduced ability for the heat dissipating sheet to dissipate heat.

### SUMMARY OF THE INVENTION

The present invention is directed to a heat dissipating sheet having excellent physical properties such as thermal conductivity, durability, and heat dissipation.

According to an aspect of the present invention, there is provided a heat dissipating sheet including a metal layer having a first surface and a second surface; at least one graphene layer having a first surface and a second surface, wherein the second surface of the graphene layer is in contact with the first surface of the metal layer; a protective layer including (a) a substrate layer having a first surface and a second surface, wherein the second surface of the substrate layer is in contact with the first surface of the graphene layer, and (b) a pigment layer in contact with the first surface of the substrate layer; an adhesive layer having a first surface and a second surface, wherein the first surface of the adhesive layer is in contact with the second surface of the metal layer; and a release layer in contact with the second surface of the adhesive layer. In this case, the heat dissipating sheet has a thermal conductivity of approximately 70 W/m·K or more in a horizontal direction.

Here, the graphene layer may include graphene and a binder.

Also, graphene may show a single peak within a wave number range of approximately 2,500 to approximately 2,800 cm⁻¹, as analyzed by Raman Spectroscopy.

In addition, graphene may have a particle size of approximately 0.1 to approximately 2 μm.

Additionally, the substrate layer may be composed of an insulation material.

According to another aspect of the present invention, there is provided an electronic device including the heat dissipating sheet.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a cross-sectional view showing a heat dissipating sheet according to one embodiment of the present invention;

FIG. 2 is a reference diagram for illustrating the heat dissipating sheet according to one embodiment of the present invention;

FIG. 3 is a cross-sectional view showing a heat dissipating sheet according to another embodiment of the present invention; and

FIGS. 4 and 5 are reference diagrams for illustrating experimental examples of the present invention.

### BRIEF DESCRIPTION OF PARTS IN THE DRAWINGS

10: metal layer
11: first surface of metal layer
12: second surface of metal layer
20: graphene layer
20a: first graphene layer
20b: second graphene layer
21: first surface of graphene layer
22: second surface of graphene layer
30: protective layer
30a: pigment layer
30a1: first surface of pigment layer
30a2: second surface of pigment layer
30b: substrate layer
30b1: first surface of substrate layer
30b2: second surface of substrate layer
40: adhesive layer
41: first surface of adhesive layer
42: second surface of adhesive layer
50: release layer
100a, 100b: heat dissipating sheet

### DETAILED DESCRIPTION OF EXEMPLARY EMBODIMENTS

Exemplary embodiments of the present invention will be described in detail below with reference to the accompanying drawings. While the present invention is shown and described in connection with embodiments thereof, it will be apparent to those skilled in the art that various modifications can be made without departing from the scope of the invention.

Unless specifically stated otherwise, all the technical and scientific terms used in this specification have the same meanings as what are generally understood by a person skilled in the related art to which the present invention belongs. In general, the nomenclatures used in this specification and the experimental methods described below are widely known and generally used in the related art.

Hereinafter, the present invention will be described in further detail.

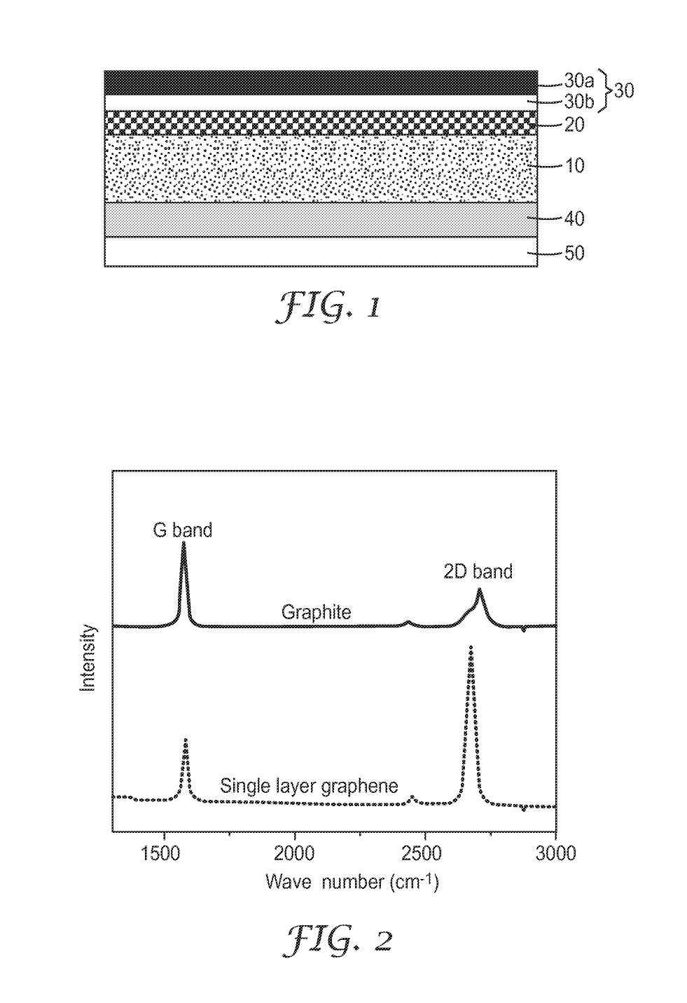

FIG. 1 is a cross-sectional view showing a heat dissipating sheet 100a according to one embodiment of the present invention. The heat dissipating sheet 100a of the present invention includes a metal layer 10 having a first surface 11 and a second surface 12, at least one graphene layer 20 having a first surface 21 and a second surface 22, a protective layer 30, an adhesive layer 40 having a first surface 41 and a second surface 42, and a release layer 50. Such a heat dissipating sheet of the present invention has an overall thermal conductivity of approximately 70 W/m·K or more, and particularly approximately 70 W/m·K to approximately 400 W/m·K in a horizontal direction of the heat dissipating sheet. Thus, when the heat dissipating sheet is applied to areas requiring heat dissipation, the heat dissipating sheet may greatly enable heat dissipation.

In the present invention, the term “first surface” refers to a top surface of each layer, and the term “second surface” represents a bottom surface of each layer.

The metal layer 10 included in the heat dissipating sheet 100a of the present invention has a first surface 11 and a second surface 12, and serves to dissipate heat with the metal layer 10 being made of a material exhibiting thermal conductivity. For example, the metal layer 10 may be composed of thin metal films and/or metal meshes. Materials of the metal layer 10 may be selected from the group consisting of, but not particularly limited to: copper (Cu), aluminum (Al), gold (Au), silver (Ag), nickel (Ni), tin (Sn), zinc (Zn), magnesium (Mg), tungsten (W), and iron (Fe), and an alloy thereof. Among these, copper, which is inexpensive and has high thermal conductivity, may be used to form the metal layer 30. The thickness of the metal layer 10 is not particularly limited, but may be in the range of approximately 8 to approximately 50 μm in consideration of the desired heat dissipation property, durability, flexibility, and the like of the heat dissipating sheet 100a.

The graphene layer 20 included in the heat dissipating sheet 100a of the present invention is in contact with the first surface 11 of the metal layer 10. More particularly, the second surface 22 of the graphene layer 20 is in contact with the first surface 11 of the metal layer 10. The graphene layer 20 serves to enhance the heat dissipation property of the metal layer 10. The thickness of the graphene layer 20 is not particularly limited, but may be in the range of approximately 2 to approximately 20 μm in consideration of the desired heat dissipation property, durability, flexibility, and the like of the heat dissipating sheet 100a.

Meanwhile, the graphene layer 20 may be formed by coating the first surface 11 of the metal layer 10 with a graphene composition including graphene, a binder and a solvent. The solvent is removed during formation of the graphene layer 20. Therefore, the graphene layer 20 is composed of graphene and the binder.

Graphene included in the graphene composition shows a single peak within a wave number range of approximately 2,500 to 2,800 cm⁻¹, as analyzed by Raman Spectroscopy. When graphene and graphite are analyzed by Raman Spectroscopy, graphene and graphite share peaks in the vicinity of a wave number of approximately 1,500 cm⁻¹ and in a wave number range of approximately 2,500 to 2,800 cm⁻¹. Referring again to the peak observed in the wave number range of approximately 2,500 to 2,800 cm⁻¹, graphite shows peaks in a wave number range of approximately 2,670 to 2,680 cm⁻¹ and at a wave number of approximately 2,720 cm⁻¹, whereas graphene shows a peak only in a wave number range of approximately 2,670 to 2,680 cm⁻¹ (see FIG. 2). That is, graphite shows double peaks in a wave number range of approximately 2,500 to 2,800 cm⁻¹, but graphene used in the present invention shows a single peak.

Such graphene has a two dimensional flat structure, which may handle approximately 100 times more electric current than copper, and transfer electrons approximately 100 times faster than the monocrystalline silicon used in conventional semiconductors. Also, graphene has a strength approximately 200 times higher than steel and a thermal conductivity 2 times higher than diamond.

Because the heat dissipating sheet 100a according to the present invention includes the graphene layer 20 formed of graphene having high thermal conductivity and strength as described above, the heat dissipating sheet of the present invention has excellent heat dissipation properties due to high thermal conductivity, and a good handling property due to improved durability. Also, because graphene is less expensive than graphite, the heat dissipating sheet according to the present invention is more economical than the conventional heat dissipating sheets in which graphite is applied.

The graphene included in the graphene composition is in a powdery state, and the size of graphene particles in a powdery state is not particularly limited, but may be in the range of approximately 0.1 to approximately 2 μm. When the size of the graphene particles is less than approximately 0.1 μm, the graphene particles may not be easily dispersed, whereas, when the size of the graphene particles exceeds approximately 2 μm, it is difficult to adjust the thickness of a graphene layer, and a surface of the graphene layer may not be uniformly formed.

Also, while the amount of graphene used is not particularly limited, it may be in the range of approximately 10 to approximately 40% by weight, based on 100% by weight of the graphene composition, when considering the coating property on the metal layer 10 and the heat dissipation property of the heat dissipating sheet.

The binder included in the graphene composition promotes a binding strength between graphene particles and/or between graphene particles and the metal layer. The binder is not particularly limited as long as it shows adhesivity. As used herein, non-limiting examples of the binder may include an epoxy resin, an acrylic resin, a urethane resin, and a urea resin. An amount of such a binder used is not particularly limited, but may be in the range of approximately 5 to approximately 20% by weight, based on 100% by weight of the graphene composition, when considering the coating property of the metal layer 10.

The solvent included in the graphene composition is not particularly limited as long as it is an organic solvent known in the related art. Non-limiting examples of the solvent, which may be used herein, may include: ethylacetate, butylacetate, isobutylacetate, dibasic ester, toluene, xylene, methylethylketone, ethylcellosolve, and butylcellosolve, which may be used alone or in combination. An amount of such a solvent used is not particularly limited, but may be in the range of approximately 30 to approximately 85% by weight, based on 100% by weight of the graphene composition, when considering the coating property of the metal layer 10.

The graphene composition according to the present invention may further include additives such as a photoinitiator, a curing agent, a dispersing agent, an antioxidant, an antifoaming agent, and a flame retardant within content ranges in which the additives do not affect the physical properties of the graphene layer 20.

Meanwhile, the graphene layer 20 formed of the graphene composition may be formed on the first surface 11 of the metal layer 10 as a single layer or may also be formed with multiple layers by repeatedly performing this formation process. That is, as shown in FIG. 3, a first graphene layer 20a is formed on the first surface 11 of the metal layer 10, and a second graphene layer 20b is also formed on the formed first graphene layer 20a. When the graphene layers 20a and 20b are formed in a multiple-layer structure as described above, the thermal conductivity of the heat dissipating sheet 100b may be improved, which leads to further improved heat dissipation property of the heat dissipating sheet.

The protective layer 30 included in the heat dissipating sheet 100a of the present invention is formed on the graphene layer 20 and serves to protect the graphene layer 20. When the graphene layer 20 is exposed to external environments, the graphene layer 20 may be damaged by physical or chemical factors. When the graphene layer 20 is damaged as described above, the thermal conductivity of the heat dissipating sheet 100a may be degraded, which results in a reduced heat dissipation ability of the heat dissipating sheet. In the present invention, however, the damage of the graphene layer 20 may be prevented by arranging the protective layer 30 on the graphene layer 20.

Such a protective layer 30 includes a substrate layer 30b, having a first surface 30b1 and a second surface 30b2, and a pigment layer 30a, having a first surface 30a1 and a second surface 30a2, coming in contact with the first surface 30b1 of the substrate layer 30b.

The substrate layer 30b is configured so that the second surface 30b2 of the substrate layer 30b is in contact with the first surface 21 of the graphene layer 20 and serves to protect the graphene layer 20. Such a substrate layer 30b may be composed of an insulation material so as to protect the graphene layer 20 and insulate the heat dissipating sheet 100a from external environments as well. This is because the substrate layer 30b is formed of an insulation material so that electrical shorts caused by unintended connections with circuits in an electronic device can be prevented. More particularly, although the heat dissipating sheet 100a is electrically introduced into circuits in an electronic device while a user is using the electronic device to which the heat dissipating sheet 100a is applied, the electrical shorts in the circuits may be prevented by means of the substrate layer 30b of the heat dissipating sheet 100a, thereby causing a decrease in damage to the electronic device. The insulation material is not particularly limited. Non-limiting examples of the insulation material, which may be used herein, may include polyethylene terephthalate (PET), polyimide (PI), polyethylene naphthalate (PEN), and the like.

The pigment layer 30a is formed on the first surface 30b1 of the substrate layer 30b and serves to prevent light from being incident on the heat dissipating sheet 100a or leaking out. Therefore, when the heat dissipating sheet 100a of the present invention is applied to a display device, not only will it result in a heat dissipation effect but it will also have an effect on the prevention of light leakage from a backlight by means of the pigment layer 30a. A pigment layer 30a is formed by coating the first surface 30b1 of the substrate layer 30b with a pigment composition including a pigment and a solvent. In this case, the desired effect of preventing light incidences and light leakage is better when the pigment layer is black. Thus, a black pigment (for example, carbon black) may be used as the pigment. Also, the solvent may be used without particular limitation as long as it is known in the related art (for example, methyl ethyl ketone). Meanwhile, a method of coating the pigment composition is not particularly limited, but slot die coating, comma coating, spray coating, and the like may be used herein.

The adhesive layer 40 included in the heat dissipating sheet 100a of the present invention has a first surface 41 and a second surface 42. The first surface 41 of the adhesive layer 40 is configured to be contact with the second surface 12 of the metal layer 10, so that the heat dissipating sheet 100 can adhere to an electronic device (or electronic parts). Materials constituting such an adhesive layer 40 are not particularly limited as long as they show adhesivity. For example, non-limiting examples of the materials, which may be used herein, may include acrylic, urethane-based, and silicone-based adhesives.

The release layer 50 included in the heat dissipating sheet 100a of the present invention is in contact with the second surface 42 of the adhesive layer 40 and serves to protect the adhesive layer 40. The release layer 50 is separated and removed from the adhesive layer 40 when heat dissipating sheet 100a is applied (attached) to the electronic device. Materials constituting such a release layer 50 are not particularly limited as long as they can be easily separated from the adhesive layer 40. For example, non-limiting examples of the materials, which may be used herein, may include polyester, polyethylene terephthalate, polyethylene, polypropylene, polyester, and silicone.

The heat dissipating sheet 100a according to the present invention may be manufactured by coating the first surface 11 of the metal layer 10 with the graphene composition to form the graphene layer 20, followed by laminating the protective layer 30 onto the first surface 21 of the formed graphene layer 20 and laminating the adhesive layer 40 and the release layer 50 onto the second surface 12 of the metal layer 10.

Here, a method of coating the first surface 11 of the metal layer 10 with the graphene composition is not particularly limited, but may include gravure coating, microgravure coating, comma knife coating, roll coating, spray coating, slot die coating, and the like.

As described above, the heat dissipating sheet according to the present invention may be used without particular limitation as long as it is applicable to zones requiring heat dissipation. More particularly, the heat dissipating sheet according to the present invention may be used in electronic devices such as notebook computers, mobile phones, TVs and computers, or electronic parts constituting the electronic devices. That is, the present invention may provide an electronic device including the above-described heat dissipating sheet.

Hereinafter, the present invention will be described in further detail by means of Examples. However, it should be understood that the following Examples are given by way of illustration of the present invention only, and are not intended to limit the scope of the present invention.

### Example 1

### 1) Preparation of Graphene Composition

A binder (available under the trade designation EP1001 from Kukdo chemical Co., LTD, Seoul, South Korea), a solvent, and a curing agent (available under the trade designation G5022X70 from Kukdo Chemical Co., LTD, Seoul, South Korea) were mixed for an hour, and graphene particles (available under the trade designation C500 from XG Science, Lancing, Mich.) having an average particle size of 1.5 μm were added thereto, and then mixed for another hour. When the mixing was completed, the mixture was milled, dispersed, and filtered to prepare a graphene composition. The components, for example, the binder, the solvent and the graphene particles, and their contents are listed in the following Table 1.

TABLE 1

| | | Content |
|---|---|---|
| Components | | (% by weight) |
| Binder | Diglycidyl ether of bisphenol A | 13 |
| Solvent | Acetate mixture | 37 |
| | (mixture of 2-butoxyethylacetate, | |
| | dimethyl glycol monobutyl | |
| | ether acetate, N-butyl acetate | |
| | in a ratio of 1.7:1:1) | |
| | Dibasic ester | 10 |

| | |
|---|---|
| Graphene particles | 40 |
| Total | 100 |

### 2) Manufacture of Heat Dissipating Sheet

The graphene composition prepared thus was coated onto one surface of a copper layer having a thickness of 25 μm, dried at 150° C. and for 3 minutes, and cured by a curing agent (available under the trade designation G5022X70 from Kukdo Chemical Co., LTD, Seoul, South Korea) to form a graphene layer having a thickness of 12 μm. Polyethylene terephthalate (a substrate layer) having a thickness of 4.5 μm, which has been print-coated with a black pigment composition (including carbon black at 30% by weight and methyl ethyl ketone at 70% by weight), was laminated onto the formed graphene layer. Thereafter, an adhesive solution having the compositions listed in the following Table 2 (available under the trade designation SA-832L from Hansung Polytech, Gyunggi, South Korea) was coated onto polyethylene terephthalate (a release layer) having a thickness of 45 μm, and dried at 110° C. and for 1 minute to form an adhesive layer having a thickness of 10 μm. Subsequently, the adhesive layer having the polyethylene terephthalate attached thereto was laminated onto the other surface of the copper layer to manufacture a heat dissipating sheet.

TABLE 2

| | Content |
|---|---|
| Compositions of adhesive solution | (% by weight) |
| 2-ethyl hexyl acrylate monomer | 25 |
| Vinyl acetate monomer | 5 |
| Butyl acetate monomer | 5 |
| Ethyl acetate | 40 |
| Toluene | 25 |

### Comparative Example 1

A heat dissipating sheet was manufactured in the same manner as in Example 1, except that the graphene layer was not formed.

### Comparative Example 2

A heat dissipating sheet was manufactured in the same manner as in Example 1, except that graphite particles (available under the trade designation CB-100 from Nippon Graphite Industries, Co., Ltd., Otsu-shi, Shiga-ken, Japan) were used at a content of 40% by weight instead of the graphene particles listed in Table 1.

### Comparative Example 3

A heat dissipating sheet was manufactured in the same manner as in Example 1, except that the graphite particles of Comparative Example 2 were used in an amount of 30% by weight instead of the graphene particles, and the binder and the solvent (including the acetate mixture at 43.3% by weight and the dibasic ester at 11.7% by weight) were used in an amount of 15% by weight and 55% by weight, respectively, as listed in Table 1.

### Experimental Example 1

### Measurement of Thermal Conductivity

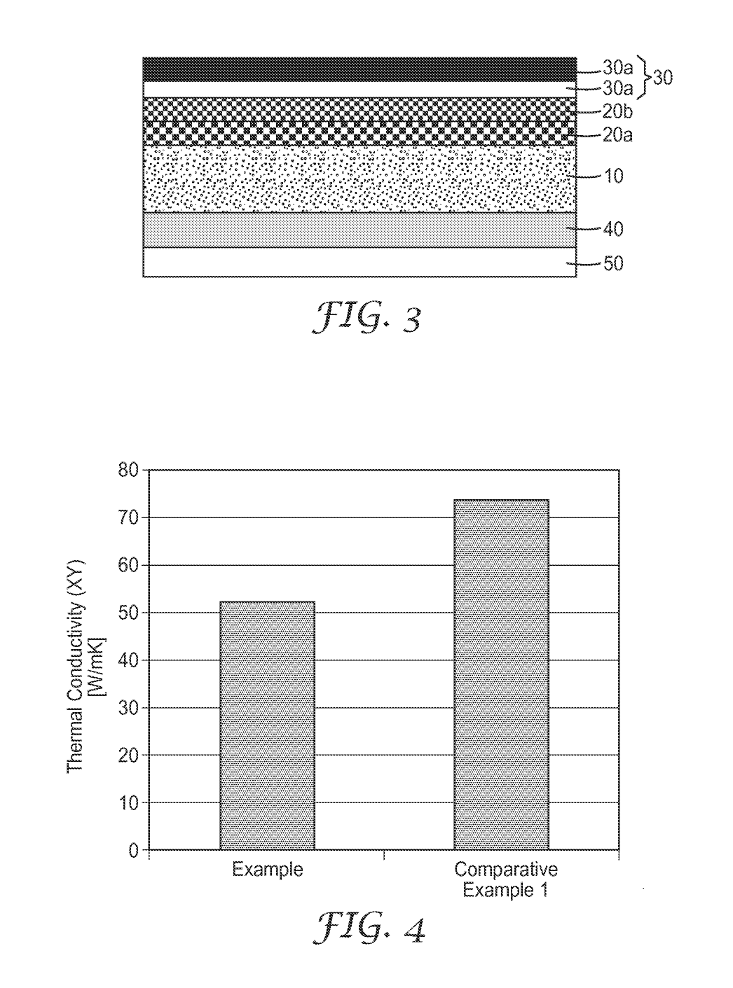

The protective layer, polyethylene terephthalate, was removed from each of the heat dissipating sheets manufactured in Example 1 and Comparative Example 1. Thereafter, the release layer-free heat dissipating sheets were measured for thermal conductivity according to the ASTM 1461 standards using a laser flash apparatus LFA447. The results are shown in FIG. 4.

Referring to FIG. 4, it could be seen that the heat dissipating sheet including the graphene layer manufactured in Example 1 had higher thermal conductivity than the heat dissipating sheet having no graphene layer manufactured in Comparative Example 1.

### Experimental Example 2

### Measurement of Thermal Conductivity

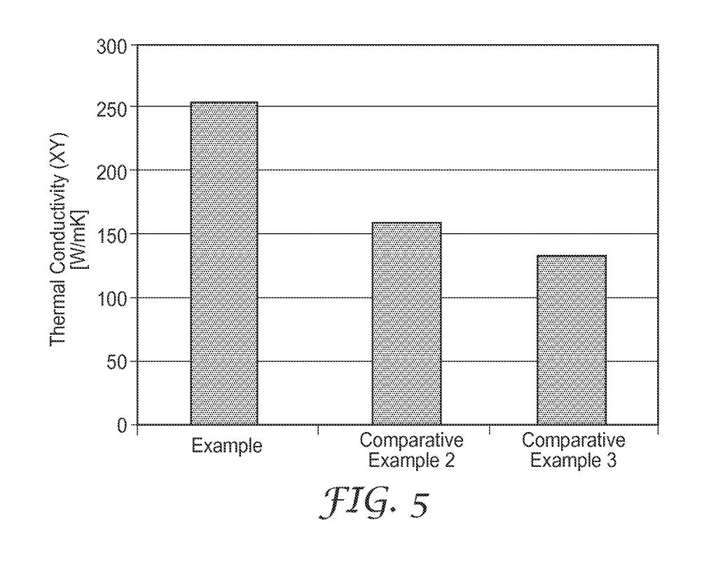

The protective layer, the adhesive layer and the release layer were removed respectively from the heat dissipating sheets manufactured in Example 1 and Comparative Examples 2 and 3. Thereafter, the heat dissipating sheets were measured for thermal conductivity according to the ASTM 1461 standards using a laser flash apparatus LFA447. The results are shown in FIG. 5.

As shown in FIG. 5, it could be seen that the heat dissipating sheet of Example 1 using the graphene particles exhibited superior thermal conductivity to the heat dissipating sheets of Comparative Examples 2 and 3 using the graphite particles.

The heat dissipating sheet according to the present invention has excellent heat dissipation and handling properties, compared to the conventional heat dissipating sheets, since the graphene layer including graphene is formed on the metal layer. Also, the heat dissipating sheet according to the present invention also exhibits excellent durability since the protective layer is formed on the graphene layer to prevent damage of the graphene layer.

It will be apparent to those skilled in the art that various modifications can be made to the above-described exemplary embodiments of the present invention without departing from the scope of the invention. Thus, it is intended that the present invention covers all such modifications provided they come within the scope of the appended claims and equivalents thereof.

1. A heat dissipating sheet comprising:
a metal layer having a first surface and a second surface;
at least one graphene layer having a first surface and a second surface, wherein the second surface of the graphene layer is in contact with the first surface of the metal layer;
a protective layer comprising (a) a substrate layer having a first surface and a second surface, wherein the second surface of substrate layer is in contact with the first surface of the graphene layer, and (b) a pigment layer is in contact with the first surface of the substrate layer;
an adhesive layer having a first surface and a second surface, wherein the first surface of the adhesive layer is in contact with the second surface of the metal layer; and
a release layer in contact with the second surface of the adhesive layer,
wherein the heat dissipating sheet has a thermal conductivity of approximately 70 W/m·K or more in a horizontal direction.

2. The heat dissipating sheet of claim 1, wherein the graphene layer comprises graphene and a binder.

3. The heat dissipating sheet of claim 2, wherein graphene shows a single peak within a wave number range of approximately 2,500 to approximately 2,800 cm⁻¹, as analyzed by Raman Spectroscopy.

4. The heat dissipating sheet of claim 2, wherein graphene has a particle size of approximately 0.1 to approximately 2 μm.

5. The heat dissipating sheet of claim 1, wherein the graphene layer has a thickness of approximately 2 to approximately 20 μm.

6. The heat dissipating sheet of claim 1, wherein the substrate layer is composed of an insulation material.

7. The heat dissipating sheet of claim 1, wherein the metal layer comprises at least one selected from the group consisting of: copper (Cu), aluminum (Al), gold (Au), silver (Ag), nickel (Ni), tin (Sn), zinc (Zn), magnesium (Mg), tungsten (W), and iron (Fe).

8. The heat dissipating sheet of claim 1, wherein the graphene layer comprises one or more layers of graphene coated on the first surface of the metal layer.

9. An electronic device comprising the heat dissipating sheet defined in claim 1.
